(19) United States
(12) Patent Application Publication
(10) Pub. No.: US 2002/0135180 A1
(43) Pub. Date: Sep. 26, 2002

(54) Connector and pipe connecting assembly

(76) Inventors: Masahiro Ando, Aichi-ken (JP); Zenichi Yasuda, Aichi-ken (JP)

Correspondence Address: PILLSBURY WINTHROP, LLP, P.O. BOX 10500, MCLEAN, VA, 22102, US

(21) Appl. No.: 10/103,136

(22) Filed: Mar. 22, 2002

(30) Foreign Application Priority Data
Mar. 26, 2001 (JP) 2001-87287(P)

(51) Int. Cl. F16L 33/00

(52) U.S. Cl. 285/239

(57) ABSTRACT

The pipe connection assembly includes a connector 10 that connects a pipe P as well as a bellows tube 30 that is pressure-fitted onto the connector 10. The bellows tube 30 includes a connecting straight tube 34 that is located at the connection end of the bellows portion 32 and is formed as a straight tube having a diameter nearly equal to the maximum outer diameter of the bellows portion 32. The connector 10 includes a connector main body 12 having a pipe insertion hole 16 for inserting a pipe P. A nipple 14 is formed around the outer circumference of the connector main body 12. The nipple 14 is located at a position at which it overlaps with the pipe P inserted in the pipe insertion hole 16. The pipe connection assembly has a construction that is advantageous in arranging and handling hoses in narrow spaces.

This application claims the benefit of and priority from Japanese Application No. 2001-87287 filed Mar. 26, 2001, the content of which is incorporated herein by reference.

### BACKGROUND OF THE INVENTION

1. Field of the Invention

The present invention pertains to a connector that connects a pipe and a bellows tube, as well as to a pipe connecting assembly.

2. Description of the Related Art

One example of known connectors is disclosed in JP No. 9-159082A FIG. 5 is a cross sectional view showing a connector that is connected to a pipe. In FIG. 5, the connector 100 includes a connector main body 102 that has a pipe insertion hole 102a. A nipple 104 is formed at one end portion of the connector main body 102. Ring-shaped protrusions 104a are formed around the outer circumference of the nipple 104, and prevent the hose T from being detached from the connector 100. Furthermore, a slit 102b that leads to the pipe insertion hole 102a is formed in the connector main body 102. The pipe P is connected to the connector 100 when a fixing member 106 is inserted in the slit 102b and engages with the pipe engagement portion Pb of the pipe P. A seal member 108 seals the pipe insertion hole 102 and the pipe P inserted into the pipe insertion hole 102.

However, because the connector main body 102 of the connector 100 is long in the axial direction of the pipe P, when the connector 100 connects the hose T to be bent relative to the pipe P, the pipeline system becomes long. As a result, the connector 100 is unsuitable for use with tubing in the engine compartment of an automobile, for example.

### SUMMARY OF THE INVENTION

The present invention to be solved is to provide a connector and pipe connecting assembly that are useful for handling hoses within a narrow piping space.

the first embodiment of the present invention provides for a connector configured to a pipe to a bellows tube having a bellows portion and a deformable connecting straight tube connected at a connection end of the bellows portion. The connector (10) comprises a connector main body having a pipe insertion hole in which the pipe is to be inserted, a seal member for sealing between a inner wall of the pipe insertion hole and the pipe inserted in the pipe insertion hole, a pipe fixing member for fixing the pipe to the connector main body, and a nipple having a fixing portion which the connecting straight tube is to be pressed and to be fitted on. The fixing portion is disposed on an outer circumference of a portion of the nipple (14) within which the pipe is to be inserted in the pipe insertion hole.

The connector pertaining to the present invention connects the pipe and the bellows tube. In other words, by inserting the pipe in the pipe insertion hole of the connector and fixing it in place using the pipe fixing member, the pipe is sealed to the connector by the seal members and thereby connected. At the same time, the bellows tube is connected by being pressure-fitted onto the nipple formed on the outer circumference of the connector main body.

Because the nipple onto which the bellows tube is pressure-fitted comprises the outer circumference of the connector main body and is located at a position at which it overlaps with the pipe inserted in the pipe insertion hole, the connector can be made short. Furthermore, because the bellows tube can be bent in the portion near the end of the pipe, [the present invention] is advantageous in arranging a brake hose or tube, and permits easy handling of a hose in a small engine compartment.

Here, the fixing portion of the nipple may comprise single or multiple rows of annular engaging protrusions that are formed around the outer circumference of the nipple and are tapered toward the end [of the connector].

The connector main body may include an annular concavity formed around the outer circumference of the nipple, wherein such annular concavity engages with the end of the connecting straight tube and serves to prevent the bellows tube from detaching.

The connector main body may further include a stopper formed at the end of the pipe insertion hole, wherein such stopper stops the movement of the seal members pressed by the pipe.

The connector main body may further include engaging slits formed in and passing through the pipe in directions perpendicular to the direction of insertion, and the pipe fixing member may operate to prevent the pipe from detaching by being inserted in the engaging slits and engaging with the pipe engagement portion.

The pipe fixing member may include a C-shaped fixing body formed around the outer circumference of the connector main body and engaging claws that protrude from the inner circumference of the fixing body, such that these engaging claws are inserted into the engaging slits and lock the pipe in place.

Another aspect of the present invention comprises a pipe connecting assembly that includes a connector that connects a pipe and a bellows tube that is pressure-fitted onto the connector, wherein the bellows tube includes a bellows portion and a connecting straight tube located at the connection end of the bellows area, and the connector includes a connector main body that has a pipe insertion hole for insertion of a pipe, seal members that seal the gap between the pipe and [the wall of] the pipe insertion hole, a pipe fixing member that fixes the pipe to the connector main body, and a nipple having a fixing portion onto which the connecting straight tube of the bellows tube is pressure-fitted and locked in place, wherein the fixing portion comprises the outer circumference of the connector main body and is positioned such that it overlaps with the pipe inserted in the pipe insertion hole.

### BRIEF DESCRIPTION OF THE DRAWINGS

FIG. 1 is a cross-sectional view showing the situation in which the pipe and the bellows tube are connected by the connector pertaining to one embodiment of the present invention;

FIG. 2 is a cross-sectional view taken on the line 2-2 of FIG. 1;

FIG. 3 is a cross-sectional view in which the component parts are disassembled;

FIG. 4 shows the operation to fix the pipe to the connector by the pipe fixing member; and

FIG. 5 is a cross-sectional view showing the connector of the prior art.

### DESCRIPTION OF THE PREFERRED EMBODIMENTS

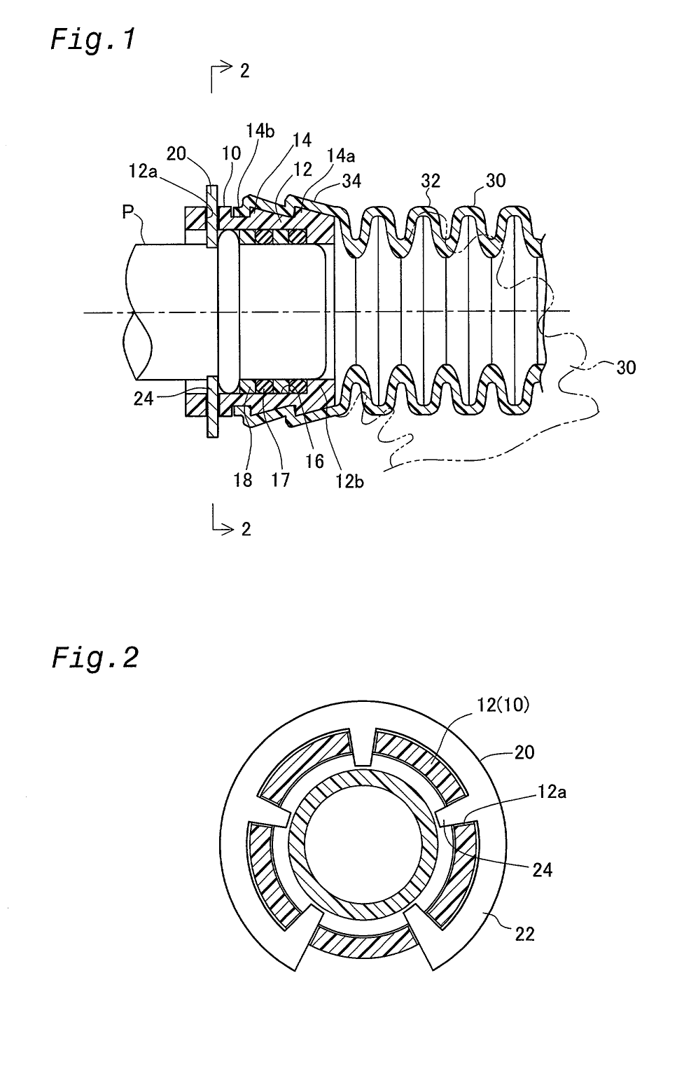

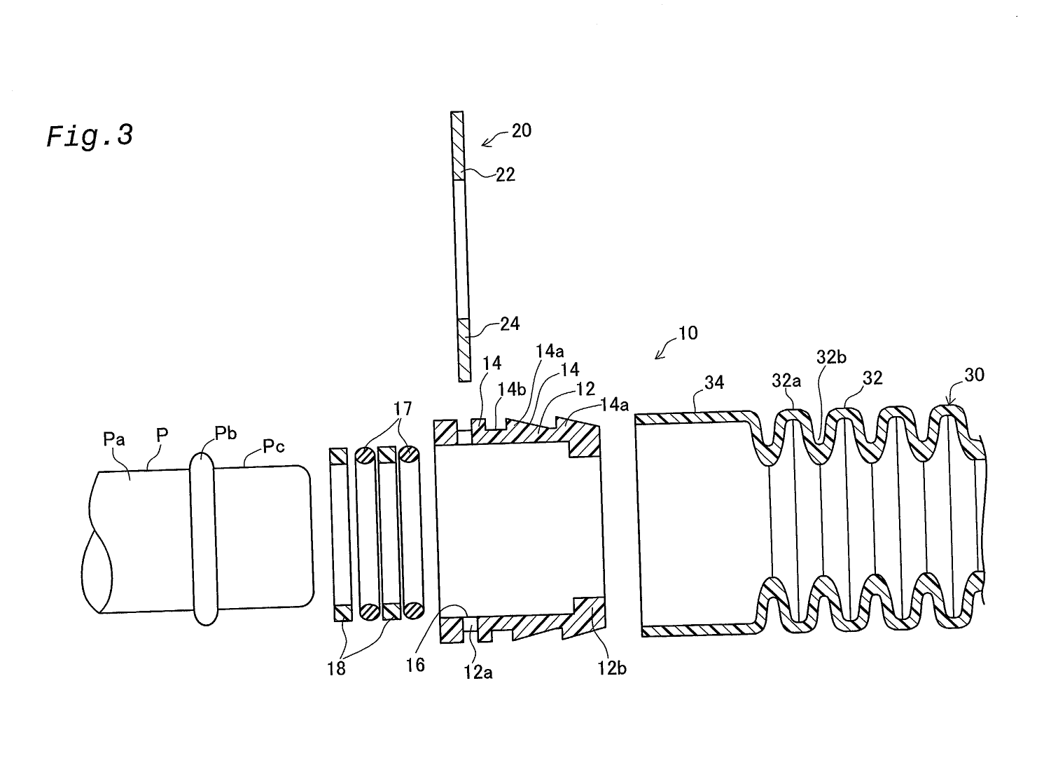

FIG. 1 is a cross-sectional view showing the situation in which a pipe P and a bellows tube 30 are connected by a connector 10 pertaining to one embodiment of the present invention, FIG. 2 is a cross-sectional view taken on the line 2-2 of FIG. 1, and FIG. 3 is a cross-sectional view in which the component parts are disassembled. The connector 10 is used for the fuel system tubing or the coolant system tubing of an automobile. The construction of each component will be explained with reference to FIG. 3.

(1) Pipe P

The pipe P is made of metal or resin and includes a pipe main body Pa having a flow passage. A annular pipe engagement portion Pb for fixing the connector 10 protrudes from the outer circumference of the pipe main body Pa. The outer circumferential surface of the pipe main body Pa disposed between the pipe engagement portion Pb and the end of the pipe main body Pa is a seal surface Pc.

(2) Connector 10

The connector 10 includes a connector main body 12, seal members 17, spacers 18 and a pipe fixing member 20.

The connector main body 12 is a cylindrical tube and comprises a nipple 14 formed on the outer circumference thereof. Two rows of annular fixing ridges 14a protrude from the outer surface of the nipple 14 for fixing the bellows tube 30. An annular concavity 14b is formed on the outer circumference of the pipe main body 12 for engaging with the end of the bellows tube 30.

The pipe main body 12 comprises a pipe insertion hole 16 for the insertion of the pipe P. The pipe insertion hole 16 is connected to the bellows tube 30. The seal members 17 and the spacers 18 are placed in the space between the wall of the pipe insertion hole 16 and the seal surface Pc of the pipe P. Each of the seal members 17 consists of O-ring and creates a seal against the seal surface Pc of the pipe P. The spacers 18 presses the side surfaces of the seal members 17 and prevent the seal members 17 from fixing insufficiently to the pipe main body 12. A stopper 12b protrudes into the opening of the pipe insertion hole 16 of the connector main body 12, as shown at the right side of the pipe insertion hole 16 in the drawing. This stopper 12b stops the movement of the seal members 17. Five engaging slits 12a are formed in the connector main body 12 around the outer circumference thereof (see FIG. 2).

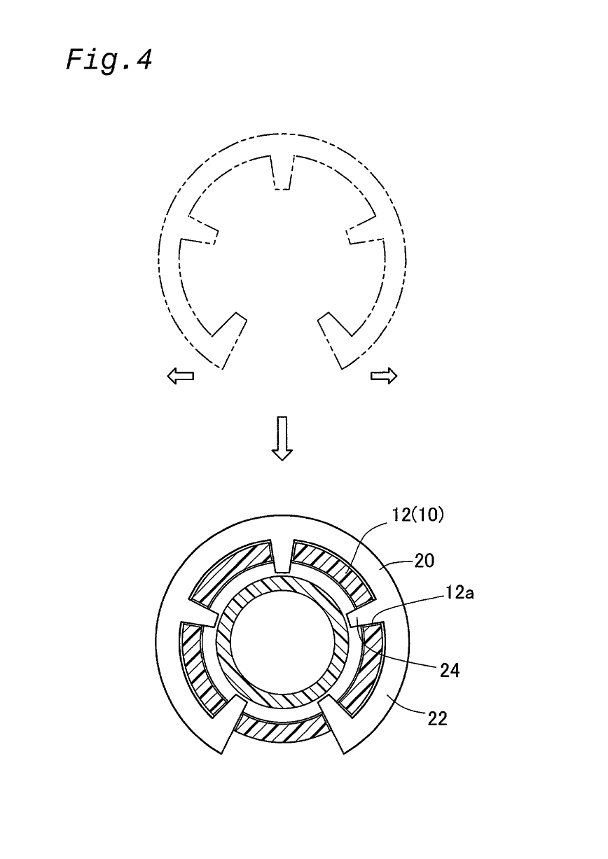

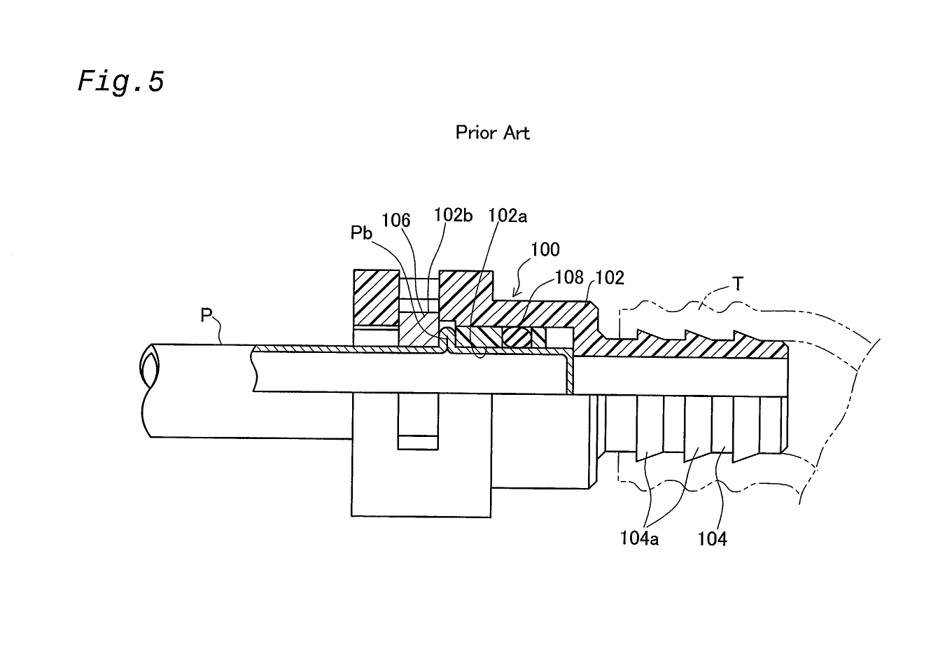

A pipe fixing member 20 is held around the outer circumference of the connector 10. FIG. 4 shows the operation to fix the pipe P to the connector main body 12 with the pipe fixing member 20. As shown in FIGS. 2 and 4, the pipe fixing member 20 includes a C-shaped fixing body 22 mounted around the outer circumferential surface of the connector main body 12 and, as well as five engaging claws 24 that protrude from the inner circumference of the fixing body 22. Each engaging claw 24 is configured to be inserted in each of the engaging slit 12a.

(3) Bellows tube 30

FIG. 3, the bellows tube 30 includes a bellows portion 32 and a connecting straight tube 34, which are integrally formed. The bellows portion 32 is formed from a continuous series of mountain parts 32a and valley parts 32b, and is flexible in the axial direction.

The connecting straight tube 34 is formed with an outer diameter approximately equal to that of the mountain parts 32a of the bellows portion 32. The inner diameter of the connecting straight tube 34 is approximately equal to or slightly smaller than the outer diameter of the nipple, such that a seal is formed when the nipple 14 is inserted [into the connecting straight tube 34].

The bellows tube 30 may be made of rubber or a resin material. Where a resin material is used, such material may comprise a single-layer material formed from nylon 12 (PA12) or polyphenylene sulfide (PPS), or a two-layer material using PPS as the inner layer and PA12 as the outer layer.

The bellows tube 30 may be manufactured by using a corrugator for molding unit. In other words, the bellows tube 30 having a connecting straight tube 34 at one end may be manufactured by conveying in a loop route a molding unit having a molding surface that conforms to the bellows portion 32 and the connecting straight tube 34 after the resin tubular body is extruded using an extruder.

The bellows tube 30 may also be manufactured using the extrusion blow molding method by changing the molds which have the molding surfaces to confirm to the configuration of the bellows portion 32 and the connecting straight tube 34 respectively.

(4) Connector 10 connecting operation

When connecting the bellows tube 30 to the connector 10, the connecting straight tube 34 of the bellows tube 30 is pressure-fitted onto the nipple 14 of the connector main body 12. When this is done, the connecting straight tube 34 elastically deforms to conform to the shape of the fixing ridges 14a of the nipple 14 and is fixed to the nipple 14. This pressure-fitting operation may be easily performed by preheating the connecting straight tube 34 to a temperature equal to or less than its heat deformation temperature.

Next, when attaching the connector 10 to the pipe P, the seal members 17 and the spacers 18 and 18 are attached to the seal surface Pc of the pipe P, and the pipe P is inserted in the pipe insertion hole 16. When this is done, the seal member 17 closer to the end of the pipe P pusses the stopper 12b and is stopped. The pipe fixing member 20 is then placed over the connector main body 12, and the engaging claws 24 are inserted via the engaging slits 12a. When this is done, the pipe fixing member 20 engages with the pipe engagement portion Pb of the pipe P and the pipe P is fixed in the connector 20.

(5) Operation and effect of the embodiment

According to the embodiment, because the nipple 14 is configured to overlaps with the pipe insertion hole 16 for fixing of the pipe P, one advantage of this embodiment is that an axial directional length of the connector 10 is shorter than that of the prior connector.

Furthermore, because the bellows tube 30 can be bent in the portion near the end of the pipe P, as indicated by the broken lines in FIG. 1, the connector 10 has an advantage in arranging a brake hose or tube and permits easy handling of the hose in a small engine compartment.

The present invention is not restricted to the above embodiments, but there may be many other modifications, changes, and alterations without departing from the scope or spirit of the main characteristics of the present invention.

What is claimed is:

1. A connector configured to connect a pipe to a bellows tube having a bellows portion and a deformable connecting straight tube connected at a connection end of the bellows portion, the connector comprising:
a connector main body having a pipe insertion hole in which the pipe is to be inserted;
a seal member for sealing between an inner wall of the pipe insertion hole and the pipe inserted in the pipe insertion hole;
a pipe fixing member for fixing the pipe to the connector main body; and
a nipple having a fixing portion which the connecting straight tube is to be pressed and to be fitted on,
wherein the fixing portion is disposed on an outer circumference of a portion of the nipple within which the pipe is to be inserted in the pipe insertion hole.

2. The connector according to claim 1, wherein the fixing portion includes annular fixing ridges that protrude from the outer circumference of the nipple.

3. The connector according to claim 2, wherein the fixing ridges are arranged in a plurality of rows.

4. The connector according to claim 1, wherein the connector main body includes an annular concavity located on an outer circumference thereof, the annular concavity being constructed and arranged to engage with an end of the connecting straight tube.

5. The connector according to claim 1, wherein the connector main body includes a stopper formed at an end wall of the pipe insertion hole, the stopper being constructed and arranged to secure the seal member pressed by the pipe.

6. The connector according to claim 1,
wherein the pipe includes a pipe engagement portion configured to protrude from an outer circumference of the pipe;
wherein the connector main body includes engaging slits formed through the connector main body in directions perpendicular to a direction of insertion of the pipe: and
wherein the pipe fixing member includes (i) a C-shaped fixing body that is to be attached around the outer circumference of the connector main body and (ii) engaging claws that protrude from an inner circumference of the fixing body, the engaging claws being constructed and arranged to lock the pipe inserted into the pipe insertion hole when the engaging claws are inserted into the engaging slits and engage with the pipe engagement portion.

7. A pipe connecting assembly configured to include a connector, a pipe and a bellows tube,
wherein the bellows tube includes a bellows portion and a deformable connecting straight tube connected with a connection end of the bellows portion;
wherein the connector includes (i) a connector main body having a pipe insertion hole for insertion of the pipe, (ii) a seal member for sealing between an inner wall of the pipe insertion hole and the pipe inserted in the pipe insertion hole, (iii) a pipe fixing member for fixing the pipe to the connector main body, and (iv) a nipple having a fixing portion which the connecting straight tube is pressed and fitted on; and
wherein the fixing portion is disposed on an outer circumference of a portion of the nipple within which the pipe is to be inserted in the pipe insertion hole.

8. The pipe connection assembly according to claim 7, wherein the connection end of the bellows portion is configured to reach an end of the connector main body when the connecting straight tube is pressed and fitted on the nipple.
